(19) United States
(12) Patent Application Publication
(10) Pub. No.: US 2023/0334261 A1
(43) Pub. Date: Oct. 19, 2023

(54) METHODS, SYSTEMS, AND MEDIA FOR IDENTIFYING RELEVANT CONTENT

(71) Applicant: Google LLC, Mountain View, CA (US)

(72) Inventors: Brian Mulford, Mountain View, CA (US); T.J. Gaffney, Mountain View, CA (US); Michael de Ridder, San Francisco, CA (US); Preethi Puducheri Sundar, Mountain View, CA (US); Colby Ranger, San Francisco, CA (US)

(21) Appl. No.: 18/031,786

(22) PCT Filed: Oct. 13, 2021
(86) PCT No.: PCT/US2021/054718

§ 371 Date: Apr. 13, 2023

Related U.S. Application Data
(60) Provisional application No. 63/091,245, filed on Oct. 13, 2020.

(51) Int. Cl. G06F 40/35; G06F 40/205; G06Q 30/0241

(52) U.S. Cl. CPC G06F 40/35; G06F 40/205; G06Q 30/0277

(57) ABSTRACT

Methods, systems, and media for identifying relevant content are provided. In some embodiments, the method includes: receiving campaign parameters that describe a content campaign, wherein the campaign parameters include at least one keyword and at least one URL; generating a target vector that describes the content campaign based on the at least one keyword and the at least one URL, wherein the target vector maps information associated with the at least one URL and information associated with the at least one keyword to an embedding space; determining a similarity of the target vector to a plurality of channel vectors associated with each of a plurality of content creators, wherein each of the plurality of channel vectors maps information associated with each of the plurality of content creators to the embedding space; selecting one or more content creators from the plurality of content creators based on the similarity of the target vector to each of the plurality of channel vectors; and causing the one or more content creators to be presented for selection to participate in the content campaign.

### CROSS-REFERENCE TO RELATED APPLICATIONS

This application claims the benefit of U.S. Provisional Pat. Application No. 63/091,245, filed Oct. 13, 2020, which is hereby incorporated by reference herein in its entirety.

### TECHNICAL FIELD

The disclosed subject matter relates to methods, systems, and media for identifying relevant content. More particularly, the disclosed subject matter relates to automatically searching for content creators or channels of content that match affinities and topicality associated with a content campaign of a brand content provider.

### BACKGROUND

Many media content sharing services provide media content (e.g., video content, audio content, etc.) to millions of users. Access to such media content presents opportunities for other content, such as advertisements, to be provided with the media content. That is, advertisers may want to identify particular media content or particular channels of media content that may be relevant to a product or entity that is being advertised.

It can be, however, difficult to identify relevant media content or relevant channels of media content. For example, it can be difficult to determine whether a particular channel of media content has an audience that is likely to be interested in particular products or services. In some cases, such determinations are made manually, which can be time and resource intensive. In another example, due to high-level taxonomies, it can be difficult to determine whether a particular channel of media content is associated with an affinity segment when no such affinity segment currently exists in an affinity taxonomy.

Accordingly, it is desirable to provide new methods, systems, and media for identifying relevant content.

### SUMMARY

Methods, systems, and media for identifying relevant content are provided.

In accordance with some embodiments of the disclosed subject matter, a method for identifying relevant content is provided, the method comprising: receiving campaign parameters that describe a content campaign, wherein the campaign parameters include at least one keyword and at least one URL; generating a target vector that describes the content campaign based on the at least one keyword and the at least one URL, wherein the target vector maps information associated with the at least one URL and information associated with the at least one keyword to an embedding space; determining a similarity of the target vector to a plurality of channel vectors associated with each of a plurality of content creators, wherein each of the plurality of channel vectors maps information associated with each of the plurality of content creators to the embedding space; selecting one or more content creators from the plurality of content creators based on the similarity of the target vector to each of the plurality of channel vectors; and causing the one or more content creators to be presented for selection to participate in the content campaign.

In some embodiments, the method further comprises parsing a page associated with the at least one URL to determine a plurality of verticals that appear on the page.

In some embodiments, the target vector combines the plurality of verticals corresponding to the at least one URL and the at least one keyword.

In some embodiments, a weight is applied to each of the plurality of verticals and the at least one keyword and wherein a total weight of the plurality of verticals corresponds with the weight applied to the at least one keyword.

In some embodiments, the method further comprises generating a plurality of query embedded vectors for the campaign, wherein the target vector is an average of the plurality of query embedded vectors.

In some embodiments, the method further comprises generating a plurality of channel embedded vectors for a channel, wherein the channel vector is an average of the plurality of channel embedded vectors.

In some embodiments, the similarity of the target vector to the plurality of channel vectors associated with each of the plurality of content creators is determined by calculating cosine similarity between the target vector and each of the plurality of channel vectors.

In some embodiments, the one or more content creators are selected from the plurality of content creators based on the cosine similarity between the target vector and a channel vector being greater than a threshold value.

In some embodiments, the method further comprises: parsing a page associated with the at least one URL to determine a plurality of verticals that appear on the page; determining an audience affinity score that estimates a portion of an audience of for the one or more content creators, wherein the audience affinity score for a content creator is based on the plurality of verticals corresponding to the at least one URL; and sorting the one or more content creators based on the audience affinity score.

In some embodiments, the method further comprises causing a user interface to be presented, wherein the user interface concurrently presents the campaign parameters with the one or more content creators for selection to participate in the content campaign, wherein each of the campaign parameters is adjustable to modify the one or more content creators that has been automatically selected as a candidate to participate in the content campaign.

In accordance with some embodiments of the disclosed subject matter, a system for identifying relevant content is provided, the system comprising a hardware processor that: receives campaign parameters that describe a content campaign, wherein the campaign parameters include at least one keyword and at least one URL; generates a target vector that describes the content campaign based on the at least one keyword and the at least one URL, wherein the target vector maps information associated with the at least one URL and information associated with the at least one keyword to an embedding space; determines a similarity of the target vector to a plurality of channel vectors associated with each of a plurality of content creators, wherein each of the plurality of channel vectors maps information associated with each of the plurality of content creators to the embedding space; selects one or more content creators from the plurality of content creators based on the similarity of the target vector to each of the plurality of channel vectors; and causes the one or more content creators to be presented for selection to participate in the content campaign.

In accordance with some embodiments of the disclosed subject matter, a non-transitory computer-readable medium containing computer-executable instructions that, when executed by a processor, cause the processor to perform a method for identifying relevant content is provided, the method comprising: receiving campaign parameters that describe a content campaign, wherein the campaign parameters include at least one keyword and at least one URL; generating a target vector that describes the content campaign based on the at least one keyword and the at least one URL, wherein the target vector maps information associated with the at least one URL and information associated with the at least one keyword to an embedding space; determining a similarity of the target vector to a plurality of channel vectors associated with each of a plurality of content creators, wherein each of the plurality of channel vectors maps information associated with each of the plurality of content creators to the embedding space; selecting one or more content creators from the plurality of content creators based on the similarity of the target vector to each of the plurality of channel vectors; and causing the one or more content creators to be presented for selection to participate in the content campaign.

In accordance with some embodiments of the disclosed subject matter, a system for identifying relevant content is provided, the system comprising: means for receiving campaign parameters that describe a content campaign, wherein the campaign parameters include at least one keyword and at least one URL; means for generating a target vector that describes the content campaign based on the at least one keyword and the at least one URL, wherein the target vector maps information associated with the at least one URL and information associated with the at least one keyword to an embedding space; means for determining a similarity of the target vector to a plurality of channel vectors associated with each of a plurality of content creators, wherein each of the plurality of channel vectors maps information associated with each of the plurality of content creators to the embedding space; means for selecting one or more content creators from the plurality of content creators based on the similarity of the target vector to each of the plurality of channel vectors; and means for causing the one or more content creators to be presented for selection to participate in the content campaign.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 shows an illustrative process for identifying relevant content in accordance with some embodiments of the disclosed subject matter.

FIG. 2 shows a schematic diagram of an illustrative system suitable for implementation of mechanisms described herein for identifying relevant content in accordance with some embodiments of the disclosed subject matter.

FIG. 3 shows a detailed example of hardware that can be used in a server and/or a user device of FIG. 2 in accordance with some embodiments of the disclosed subject matter.

FIG. 4 shows an illustrative example of a user interface for receiving campaign parameters in accordance with some embodiments of the disclosed subject matter.

FIG. 5 shows another illustrative example of a user interface for receiving campaign parameters in accordance with some embodiments of the disclosed subject matter.

FIG. 6 shows an illustrative example of a user interface for presenting content creators or channels that match a campaign based on received campaign parameters in accordance with some embodiments of the disclosed subject matter.

### DETAILED DESCRIPTION

In accordance with various embodiments, mechanisms (which can include methods, systems, and media) for identifying relevant content are provided.

A content provider, such as a brand content provider (e.g., a brand advertiser) may desire to match a content campaign with one or more content creators. For example, given one or more Uniform Resource Locators (URLs), one or more keywords, and/or a budget for a content campaign, the mechanisms described herein can automatically ingest the one or more URLs and the one or more keywords as descriptors of the content campaign to generate a set of content creators or channels of content that match the affinities and topicality associated with the brand content provider while maximizing views of the content items in the content campaign. The brand content provider can, for example, select one or more of the matching content creators to participate in the content campaign.

In some embodiments, the mechanisms described herein can identify content creators or channels of media content that are suitable matches for a content campaign. In some embodiments, the mechanisms can receive any suitable input parameters related to the content campaign that indicate a topic or genre related to a product or service being advertised, a target audience demographic, a minimum video quality of videos in which advertisements are to be presented, and/or any other suitable parameters. For example, in some embodiments, the input parameters can include a Uniform Resource Locator (URL) that is associated with an entity corresponding to the content campaign or that otherwise describes the target audience for the content campaign. As another example, in some embodiments, the input parameters can include one or more keywords that describe a product or a service associated with the content campaign or that otherwise describe the target audience for the content campaign.

In some embodiments, the mechanisms can identify content creators or channels of content that are suitable matches for a content campaign in any suitable manner. For example, in some embodiments, the mechanisms can identify channels that are relevant to a topic of the content campaign. As a more particular example, in some embodiments, the mechanisms can generate a vector in any suitable embedding space that represents a relevance of different topics to the content campaign. Continuing further with this particular example, in some embodiments, the mechanisms can generate vectors in the embedding space for different channels of media content that represent a relevance of different topics to each channel. Continuing still further with this particular example, in some embodiments, the mechanisms can then identify media content channels each associated with multiple topics that are most similar to the content campaign by computing any suitable similarity metric between the vector associated with the content campaign and the one or more vectors associated with the media content channels (e.g., cosine similarity, Euclidean distance, and/or any other suitable similarity metric).

In some embodiments, the mechanisms can further identify content creators or channels of media content that are suitable matches for the content campaign based on any other suitable criteria, such as based on an affinity of audiences of the channel. For example, in some embodiments, the mechanisms can identify channels of media content that have relatively high audience affinity. In some embodiments, by identifying channels of media content that are particularly relevant based on topic to the content campaign and that have audiences with relatively high affinity, the mechanisms can identify content creators or channels of media content that have a relatively high advertising value (e.g., by having an audience that is interested in a topic associated with the content campaign and that is likely to view content associated with the channel and is therefore likely to view content items, such as advertisements, associated with the channel).

Note that, in some embodiments, the mechanisms can filter content creators or channels based on any criteria in addition to topic and affinity. For example, in some embodiments, the mechanisms can filter content creators or channels based on how well an audience of the content creator or channel matches target demographics specified for the content campaign. As another example, in some embodiments, the mechanisms can filter content creators or channels based on a minimum video quality criteria specified in input parameters associated with the content campaign.

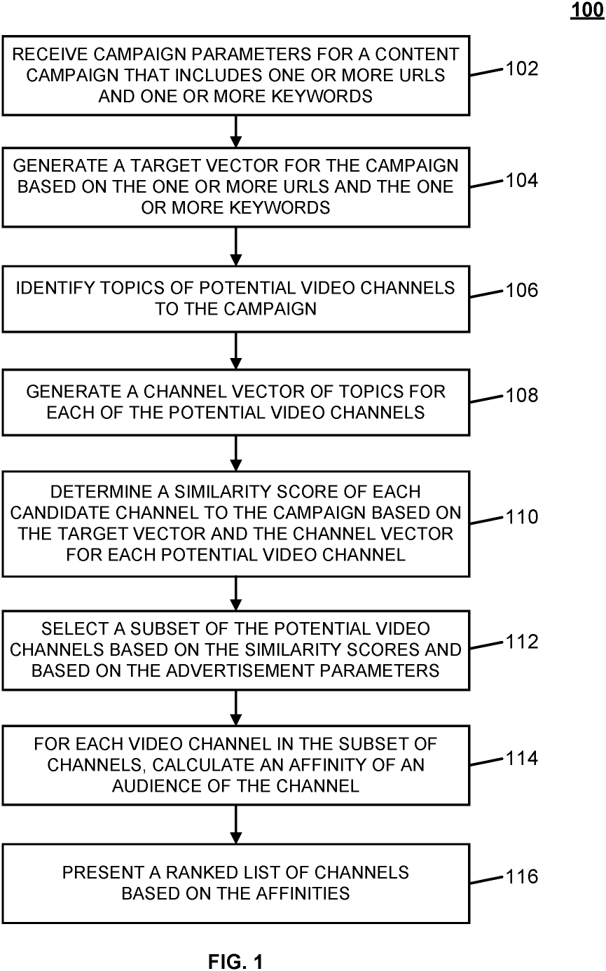

In some embodiments, the mechanisms can present content creators or channels identified as suitable for the content campaign to a creator of the content campaign. For example, in some embodiments, the identified channels can be presented in any suitable ranked order, as described below in connection with FIG. 1. In some embodiments, the identified channels can be presented in a user interface for selection by a creator of the content campaign.

It should be noted that, although the embodiments described herein generally describe automatically selecting content creators as candidates for participating in a content campaign based on received parameters that describe the content campaign, this is merely illustrative. In a travel search implementation, given one or more Uniform Resource Locators (URLs) that describe the desired location or vacation experience, one or more keywords, and/or a budget for a vacation, the mechanisms described herein can automatically ingest the one or more URLs and the one or more keywords as descriptors of the desired vacation to generate a set of proposed vacation results that match the affinities and topicality associated with the desired vacation.

These and other features for identifying relevant content are described further in connection with FIGS. 1 - 6.

Turning to FIG. 1, an illustrative example 100 of a process for identifying relevant content is shown in accordance with some embodiments of the disclosed subject matter. In some embodiments, blocks of process 100 can be executed by any suitable device, such as a server that hosts media content items and streams media content items to user devices. In some such embodiments, the server can execute blocks of process 100 to identify one or more channels of media content suitable for a particular content campaign.

Process 100 can begin at 102 by receiving campaign parameters for a campaign that include one or more URLs and one or more keywords. In some embodiments, process 100 can receive the campaign parameters in any suitable manner. For example, in some embodiments, process 100 can receive the campaign parameters from a user device (e.g., a user device of a user associated with a business or entity purchasing advertisement slots associated with the campaign) via a user interface presented on the user device. In another example, in some embodiments, process 100 can allow a content provider to create a content campaign associated with one or more content items using tools provided by a content management system in which user interfaces can be presented to the content provider, for example, either through an online interface provided by the content management system or as an account management application installed and executed locally at a content provider’s client device. In continuing this example, a content provider can, using the user interfaces, provide content parameters which define a content campaign.

It should be noted that a creator of a content campaign may not be able to describe a target audience for the content campaign in the form of keywords. Moreover, a keyword that has been provided by the creator of the content campaign, such as “lettuce” or “high fiber diet,” may not match a known audience segment. As such, process 100 can allow the creator of the content campaign to provide any suitable campaign parameters that describe the content campaign, such as URLs that are associated with pages having content that a target audience of the content campaign would be interested, URLs that are associated with a product or a service of the brand content provider, etc.

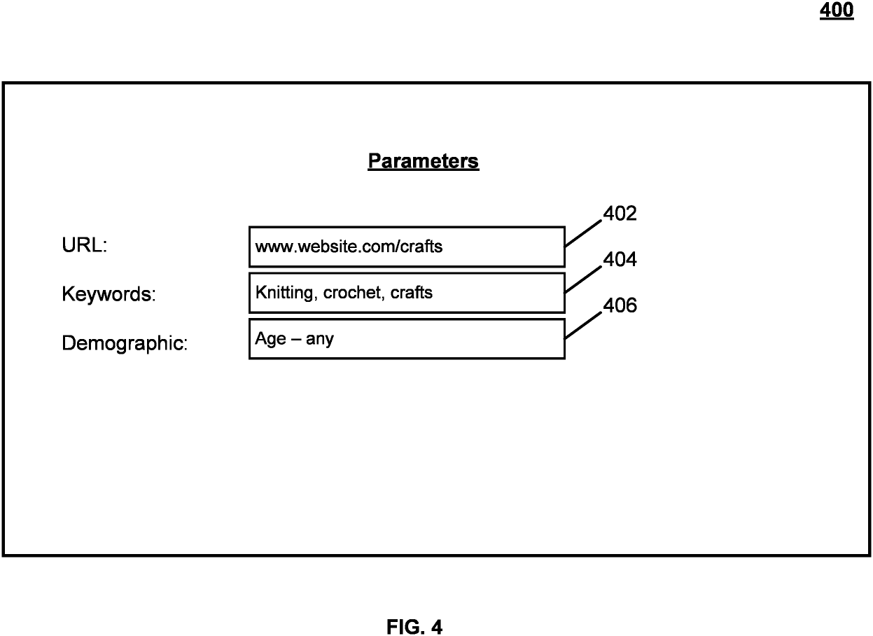

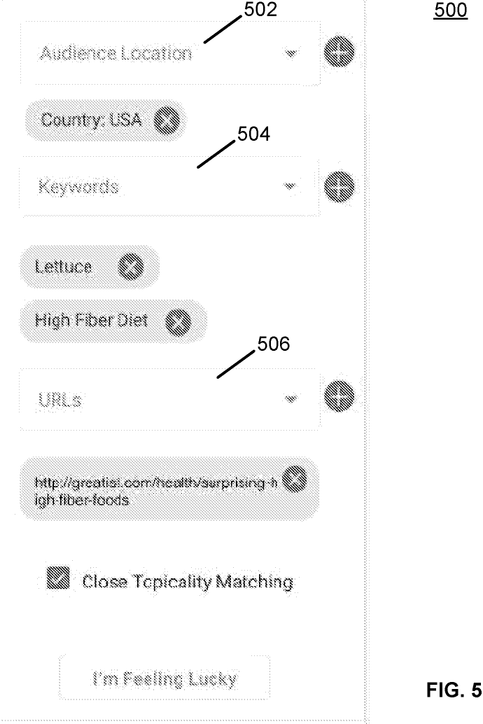

Turning to FIGS. 4 and 5, illustrative examples 400 and 500 of user interfaces for receiving campaign parameters are shown in accordance with some embodiments of the disclosed subject matter. As illustrated, in some embodiments, user interface 400 and user interface 500 can include any suitable input elements for receiving the campaign parameters. For example, as shown in FIG. 4, user interface 400 can include input elements for receiving a URL at 402, one or more keywords related to the content campaign at 404, and/or one or more target demographic criteria at 406 (e.g., a target age range of an audience of presented advertisements, a gender of an audience that a brand content provider desires to reach, a country in which an audience that a brand content provider desires to reach, and/or any other suitable demographic criteria). In another example, as shown in FIG. 5, user interface 500 can include input elements for receiving a target audience location at 502, one or more keywords that describe the content campaign at 504, and one or more URLs from the brand content provider’s website or from pages that describe the content campaign at 506. In some embodiments, any other suitable parameters can be included, such as a target video quality of videos in which advertisements or other content items are to be inserted, a target device type of user devices that present a particular advertisement or content item associated with the campaign, cost or pricing information (e.g., a maximum amount to be spent in association with the campaign, and/or any other suitable cost or pricing information) and/or any other suitable campaign parameters.

It should be noted that any suitable information can be received as a descriptor of the campaign. For example, a URL received at 402 can include a URL corresponding to a page from a brand content provider’s website. In another example, a URL received at 402 can include a URL corresponding to a page that is relevant to the campaign. In a more particular example, as shown in FIGS. 4 and 5, the URL “www.website.com/crafts” in 402 and the URL “http://greatist.com/health/surprising-high-fiber-foods” in 506 can be provided to describe that a target audience for the content campaign would be interested in the content of such a page. In continuing this example, the URL received at 402 and the URL received at 506 can be supplemented with additional keywords that describe the campaign (e.g., the keywords “knitting,” “crochet,” and “crafts” in 404, the keywords “lettuce” and “high fiber diet” in 504, etc.) or additional information that describes the target audience of the campaign (e.g., the demographic information “any age” in 406, the audience location information “USA” in 502).

It should also be noted that, in addition to targeted audience demographics and channel quality that may be directly used to search for matching content creators and/or the channels of content provided by content creators, process 100 can expand the search for matching content creators and/or the channels of content provided by content creators to include parameters that are described by the keywords and/or URLs that have been received (e.g., using the user interfaces shown in FIGS. 4 and 5).

Referring back to FIG. 1, at 104, process 100 can, in some embodiments, generate a target vector for the content campaign based on the one or more URLs and the one or more keywords. In some embodiments, the target vector can indicate any suitable information about the content campaign, such as one or more topics associated with the products or services to be advertised, and/or any other suitable information. In some embodiments, the target vector can be a vector of any suitable size and that is generated in any suitable embedding space that maps information associated with the URL and the keywords to the embedding space.

In some embodiments, process 100 can generate the target vector in any suitable manner. For example, in some embodiments, process 100 can identify one or more pages related to the received URL, referred to herein as verticals. As a more particular example, in an instance in which the received URL is “www.website.com/crafts”, as shown in FIG. 4, process 100 can identify related pages, such as “www.website.com,” “www.website.com/art,” and/or any other suitable pages. Continuing further with this example, in some embodiments, process 100 can parse or otherwise identify one or more topics associated with each of the pages based on any suitable information, such as identification of words included in the page, identification of images included in the page, identification of videos included in the page, and/or any other suitable information. Continuing still further with this example, in some embodiments, process 100 can generate the target vector based on the topics associated with the URL and the related pages and based on the one or more keywords included in the campaign parameters described above in 102 in any suitable manner. As a more particular example, in some embodiments, process 100 can identify a top N (e.g., top five, top ten, and/or any other suitable number) topics or keywords, and can generate a vector that represents a degree of relevance of each of the top N topics or keywords. As a specific example, in an instance in which the URL is “www.website.com/crafts” and in which the keywords are “knitting” and “art,” process 100 can identify the top N keywords as “crafts,” “knitting,” “art,” “decorations,” and can assign a strength to each topic that indicates a relevance of each topic to the URL and the keywords, such as [1.0, 1.0, 1.0, 0.3].

In a more particular example, process 100 can include a URL processor that ingests the received URL as input and parses the text of the associated pages to determine the verticals that appear on the pages. An illustrative example of verticals can include “Arts & Entertainment/TV & Video/Online Video” with a vertical weight of 0.8 and “Home & Garden/Domestic Services/Cleaning Services” with a vertical weight of 0.2. In continuing this example, process 100 can include a keyword processor that ingests the received keywords as input, where the keywords can be combined with the determined verticals. In some instances, the keywords can be provided with equal weight to the verticals from the received URL. For example, if the URL has two verticals of weights 0.8 and 0.2 and three keywords were also received, the verticals can be counted with weights of 0.2 (or 0.8 multiplied by 0.25) and 0.05 (or 0.2 multiplied by 0.25), respectively, and each of the three keywords can be counted with a weight of 0.25.

It should also be noted that, in some embodiments, multiple query embedded vectors can be generated for the content campaign based on the one or more URLs and the one or more keywords. For example, in response to receiving multiple URLs, a query embedded vector can be generated for each of the received URLs in combination with the one or more received keywords. In continuing this example, the target vector can be an average of the multiple query embedded vectors.

In some embodiments, in response to generating the multiple query embedded vectors for the content campaign based on the one or more URLs and the one or more keywords and/or the target vector for the content campaign based on the one or more URLs and the one or more keywords, process 100 can determine the relevance between the received URL and a channel identify video channels that topically match the multiple query embedded vectors for the content campaign based on the one or more URLs and the one or more keywords and/or the target vector for the content campaign based on the one or more URLs and the one or more keywords.

In some embodiments, at 106, process 100 can identify topics associated with one or more potential video channels. In some embodiments, each potential video channel can be a video channel that is a candidate for recommendation for inclusion in the content campaign. For example, each channel can be associated with one or more topics. In another example, process 100 can identify the top N topics having a relevance score of greater than a threshold value for association with a video channel.

In some embodiments, at 108, process 100 can generate a channel vector of topics for each of the potential video channels. In some embodiments, process 100 can generate the vector in any suitable manner. For example, similar to what is discussed above in connection with 104, process 100 can generate a vector for each channel that indicates a relevance of a top N topics associated with the channel to the channel. As a more particular example, for a first channel associated with a topic of “knitting,” process 100 can generate a vector that indicates a relevance of different topics, such as “crafts,” “knitting,” “art,” “decorations,” to the channel. As a specific example, the vector can be [0.8, 1.0, 0.3, 0.1], and/or any other suitable vector.

It should also be noted that, in some embodiments, multiple channel embedded vectors can be generated for each topic of a potential video channel. In continuing this example, the channel vector can be an average of the multiple channel embedded vectors.

Alternatively, in some embodiments, process 100 can identify a group of clusters of potential video channels. In some embodiments, each potential video channel can be a video channel that is a candidate for recommendation for inclusion in the content campaign. In some embodiments, each cluster can include any suitable number (e.g., one, two, ten, twenty, and/or any other suitable number) of potential video channels.

In continuing this example, process 100 can identify the group of clusters of potential video channels in any suitable manner. For example, in some embodiments, process 100 can identify one or more clusters, each including one or more potential video channels, based on a topic associated with video channels included in the cluster, where the topic of the cluster is identified as relevant to one or more topics associated with the URL and/or keywords described above in connection with 102 and 104. As a more particular example, continuing with the example URL of “www.website.com/crafts,” process 100 can identify a first cluster associated with a topic of “knitting,” a second cluster associated with a topic of “crocheting,” and a third cluster associated with a topic of “accessories.” In some embodiments, process 100 can identify clusters in any suitable manner. For example, in some embodiments, video channels can be grouped into clusters based on topics associated with the video channels, and process 100 can identify any suitable number (e.g., one, two, five, and/or any other suitable number) of relevant clusters. Process 100 can then generate a vector for each cluster of potential video channels included in the group of clusters. In some embodiments, process 100 can generate the vector in any suitable manner. For example, similar to what is discussed above in connection with 104, process 100 can generate a vector for each cluster that indicates a relevance of a top N topics associated with the cluster to the cluster. As a more particular example, for a first cluster associated with a topic of “knitting,” process 100 can generate a vector that indicates a relevance of different topics, such as “crafts,” “knitting,” “art,” “decorations,” to the cluster. As a specific example, the vector can be [0.8, 1.0, 0.3, 0.1], and/or any other suitable vector. It should also be noted that, in some embodiments, multiple channel embedded vectors can be generated for each cluster of potential video channels in the group of clusters. In continuing this example, the channel vector can be an average of the multiple channel embedded vectors.

Referring back to FIG. 1, at 110, process 100 can, in some embodiments, generate a similarity score of each candidate channel to the content campaign based on the channel vector for each channel and the target vector associated with the content campaign. In some embodiments, process 100 can generate the similarity score in any suitable manner. For example, in some embodiments, process 100 can calculate any suitable type of similarity between the vector associated with the channel and the target vector, such as a cosine similarity score. In a particular example, to determine the relevance between a URL and other campaign parameters and a channel of content, process 100 can generate suitable vectors in an embedding space and determine the cosine similarity between the pair of embedded vectors.

Note that, in some embodiments, the vector associated with the cluster and the target vector can each be normalized in any suitable manner prior to calculating the similarity score.

In some embodiments, at 112, process 100 can select a subset of the channels based on the similarity scores and can filter channels based on the campaign parameters. In some embodiments, process 100 can select the subset of the channels in any suitable manner. For example, in some embodiments, process 100 can select the top N channels (e.g., the top three, the top five, the top 10%, and/or any other suitable number of channels) with the highest similarity scores. In another example, in some embodiments, process 100 can select channels having a similarity score greater than a particular threshold value.

In some embodiments, process 100 can filter the channels in any suitable manner.

For example, in some embodiments, process 100 can filter out channels that are associated with a demographic group not included in the campaign parameters received at 102. It should be noted that a channel is unlikely to have all of its viewers from a specific demographic group. As such, in some instances, process 100 can select channels from the set of channels that have the target demographic group from the campaign parameters received at 102 as one of the top N demographic groups for the channel. Alternatively, in some instances, process 100 can select a channel from the set of channels in which a threshold percentage of its viewers fall within the target demographic group from the campaign parameters received at 102.

As another example, in some embodiments, process 100 can filter out channels that do not meet minimum video quality standards specified in the campaign parameters received at 102.

As yet another example, in some embodiments, process 100 can filter out channels associated with a location that is outside of the audience location specified in the campaign parameters received at 102. It should be noted that a channel is unlikely to have all of its viewers from a specific audience location. As such, in some instances, process 100 can select channels from the set of channels that have the target audience location from the campaign parameters received at 102 as one of the top N audience locations for the channel. Alternatively, in some instances, process 100 can select a channel from the set of channels in which a threshold percentage of its viewers fall within the target audience location from the campaign parameters received at 102.

In some embodiments, process 100 can further identify content creators or channels of media content that are suitable matches for the content campaign based on any other suitable criteria, such as based on an affinity of audiences of the channel. For example, in some embodiments, process 100 can identify channels of media content that have relatively high audience affinity. In some embodiments, by identifying channels of media content that are particularly relevant based on topic to the content campaign and that have audiences with relatively high affinity, process 100 can identify content creators or channels of media content that have a relatively high advertising value (e.g., by having an audience that is interested in a topic associated with the content campaign and that is likely to view content associated with the channel and is therefore likely to view content items, such as advertisements, associated with the channel).

Turning back to FIG. 1, at 114, for each channel in the subset of channels, process 100 can, in some embodiments, calculate an affinity of an audience of the channel to topics associated with the URL provided in the campaign parameters. In some embodiments, the affinity can indicate any suitable information, such as a likelihood of a viewer of videos associated with the channel viewing other videos associated with other channels similar to the channel, a likelihood of a viewer of videos associated with the channel navigating to an external website associated with the channel, a likelihood of a viewer of videos associated with the channel engaging with or interacting with advertisements included in videos of the channel, a likelihood of a viewer of videos associated with the channel engaging with (e.g., endorsing, sharing, commenting on, etc.) the video, and/or any other suitable information.

In some embodiments, process 100 can determine the affinity of the audience in any suitable manner. For example, in some embodiments, process 100 can determine the affinity of the audience of the channel based on viewing histories of users who have viewed videos associated with the channel. In some embodiments, the viewing histories can indicate a percentage of videos associated with the channel that users have viewed, a percentage of videos associated with the channel that users have engaged with (e.g., commented on, endorsed, shared, etc.), and/or any other suitable viewing history information. As another example, in some embodiments, process 100 can determine the affinity of the audience of the channel based on a number of subscriptions of users to the channel.

In some embodiments, process 100 can calculate total affinity of each channel by combining affinity across multiple topic clusters in any suitable manner. For example, in some embodiments, process 100 can calculate total affinity across multiple topic clusters using:

$$\text{Pr} \left({∪}_{i} {A}_{i}\right) = \text{Pr} \left({\left({⋂}_{i} {A}_{i}^{C}\right)}^{C}\right) = 1 - {\prod }_{i} \left(1 - \text{Pr} \left({A}_{i}\right)\right) .$$

where Aᵢ is an audience affinity for an ith cluster. Note that, in some embodiments, process 100 can calculate total affinity across multiple clusters by assuming correlation of affinities for channels within a cluster, and independence of affinities across clusters. That is, process 100 can estimate total affinity of the audiences across the different clusters by assuming independence between the affinities for different clusters and calculating combined probability of having the affinity for any cluster using the above-mentioned formula.

In some embodiments, at 116, process 100 can present a ranked list of channels based on the calculated affinities. In some embodiments, process 100 can rank the list of channels based on the affinities in any suitable manner, for example, from highest affinity to lowest affinity. In some embodiments, process 100 can present a subset of the channels selected based on the affinities, such as by identifying a subset of the channels with affinities that exceed a predetermined threshold and/or by identifying the top N channels.

Note that, in some embodiments, process 100 can rank the channels based on any suitable combination of the calculated affinities and any other suitable information, such as a number of subscribers to the channel, a number of total views of videos of the channel, and/or any other suitable information. In some embodiments, by ranking channels based on affinity and any suitable metrics that indicate predicted views of an advertisement presented in connection with the channel, a channel rank can indicate a value of such an advertisement by indicating both a likelihood the advertisement will be viewed and a value of the advertisement.

In some embodiments, process 100 can present the ranked list of channels in any suitable manner. For example, in some embodiments, process 100 can present a user interface that includes an indication of each channel in the ranked list. In some embodiments, an indication of the channel can include any suitable information about the channel, such as a name of the channel, a number of videos currently included in the channel, a name of a creator of the channel, a number of subscribers to the channel, a number of total views of videos associated with the channel, a number of views of videos associated with the channel within a predetermined time period (e.g., within the last week, within the last month, and/or any other suitable time period), and/or any other suitable information.

Note that, in some embodiments, the user interface can include any suitable selectable inputs that allows a user of the user interface to select one or more channels for inclusion in the content campaign.

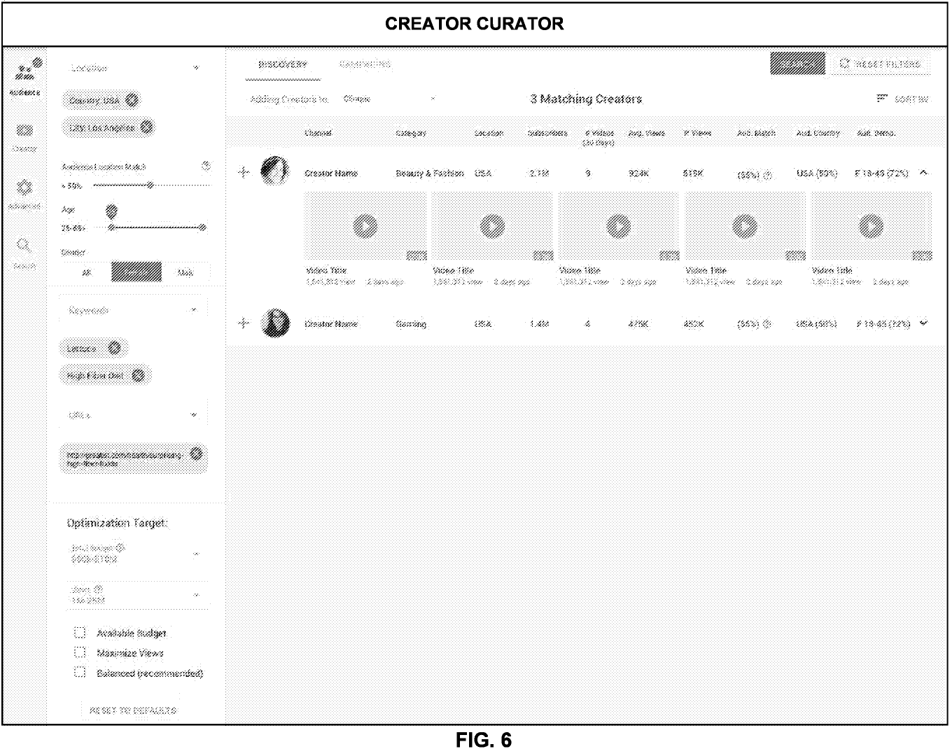

Turning to FIG. 6, an illustrative example of a user interface for presenting matched content creators or matching channels of content based on received campaign parameters is shown in accordance with some embodiments of the disclosed subject matter. As illustrated, in some embodiments, user interface 600 can include the received campaign parameters from FIG. 5. As also shown in FIG. 6, each matching content creator or channel can be provided with any suitable information, such as a category (e.g., “Beauty & Fashion,” “Gaming,” etc.), a location (e.g., “USA”), a number of subscribers, a number of content items provided over a particular period of time (e.g., videos posted over the last 30 days), a number of average views of the content items, and one or more matching scores (e.g., an audience matching score, an audience country score, an audience demographics store, etc.), etc. In some embodiments, content items, such as videos, video previews, or any other suitable video representation, can be presented along with each matching content creator or channel. In continuing this example, a brand content provider can select one or more videos or other content items associated with a channel to determine whether the channel is suitable for the content campaign.

In some embodiments, different content creators or channels can be selected based on target optimization parameters. For example, as shown in FIG. 6, the target optimization parameters can include a target budget, a target number of views, and a target optimization (e.g., available budget, maximize view, or balanced). In continuing this example, in response to selecting the target optimization of available budget, process 100 can be configured to automatically select the largest number of matching creators or channels feasible to satisfy a given budget. Alternatively, in response to selecting the target optimization of maximize view, process 100 can be configured to automatically select the largest number of matching creators or channels feasible to satisfy a desired number of views. It should be noted that process 100 can transmit a warning notification to the creator of the content campaign if, for example, it is estimated that the given budget is not enough to achieve the desired number of views.

In some embodiments, in response to selecting a balanced target optimization, process 100 can balance the automatic selection of matching creators or channels to optimally reach the expected views with a given budget. This can include, for example, selecting different types of content creators, such as top content creators, mid-content creators, and aspiring content creators (e.g., based on number of subscribers or audience size, based on cost per view in a particular vertical, based on sponsored videos per channel, based on demographic match, etc.). In a more particular example, upon selecting a balanced target optimization, process 100 can use a Gaussian distribution to select a few top content creators (or highly established content creators) and a few aspiring content creators with mostly mid-content creators.

In some embodiments, in response to selecting one of the content creators or channels (e.g., one of the matching channels in FIG. 6), a brand content provider can contact, hire, and/or manage a content creator for a content campaign.

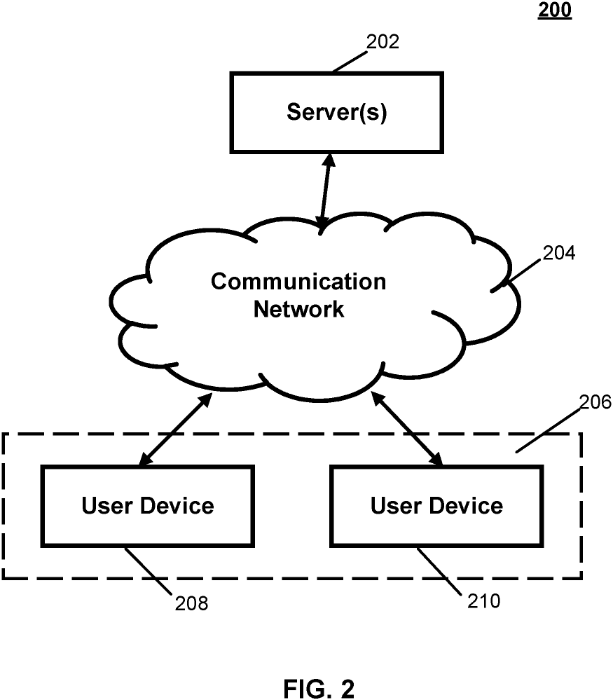

Turning to FIG. 2, an example 200 of hardware for identifying relevant content that can be used in accordance with some embodiments of the disclosed subject matter is shown. As illustrated, hardware 200 can include a server 202, a communication network 204, and/or one or more user devices 206, such as user devices 208 and 210.

In some embodiments, server 202 can be any suitable server for identifying particular channels of video content suitable for a particular content campaign. For example, in some embodiments, server 202 can receive any suitable information from a creator of an content campaign (e.g., a website URL, one or more keywords, target demographic information, and/or any other suitable information), and can identify one or more channels of content relevant to the content campaign, as shown in and discussed above in connection with FIG. 1.

Communication network 204 can be any suitable combination of one or more wired and/or wireless networks in some embodiments. For example, communication network 204 can include any one or more of the Internet, an intranet, a wide-area network (WAN), a local-area network (LAN), a wireless network, a digital subscriber line (DSL) network, a frame relay network, an asynchronous transfer mode (ATM) network, a virtual private network (VPN), and/or any other suitable communication network. User devices 206 can be connected by one or more communications links to communication network 204 that can be linked via one or more communications links to server 202. The communications links can be any communications links suitable for communicating data among user devices 206 and server 202, such as network links, dial-up links, wireless links, hard-wired links, any other suitable communications links, or any suitable combination of such links.

User devices 206 can include any one or more user devices suitable for receiving and transmitting parameters for content campaigns, presenting media content items, presenting advertisements, and/or for any other suitable purpose(s). For example, in some embodiments, user devices 206 can include a desktop computer, a laptop computer, a mobile phone, a tablet computer, and/or any other suitable type of user device.

Although server 202 is illustrated as one device, the functions performed by server 202 can be performed using any suitable number of devices in some embodiments. For example, in some embodiments, multiple devices can be used to implement the functions performed by server 202.

Although two user devices 208 and 210 are shown in FIG. 2 to avoid over-complicating the figure, any suitable number of user devices, and/or any suitable types of user devices, can be used in some embodiments.

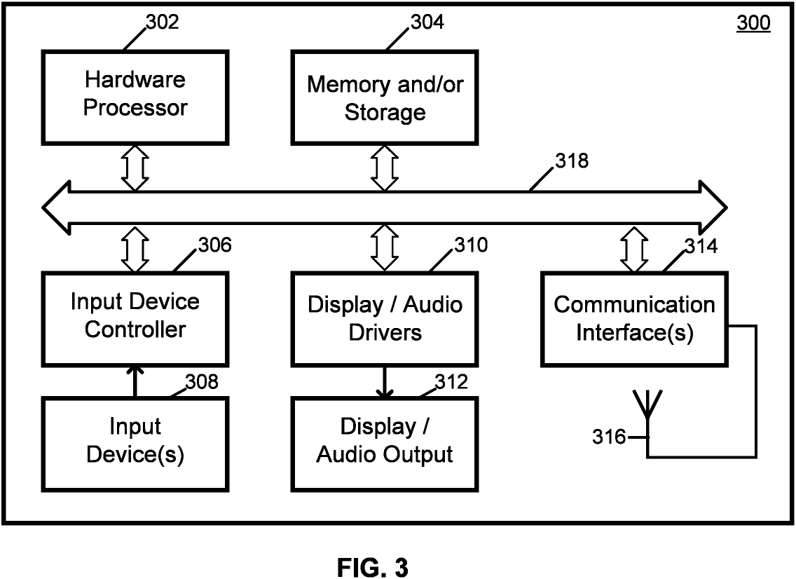

Server 202 and user devices 206 can be implemented using any suitable hardware in some embodiments. For example, in some embodiments, server 202 and user devices 206 can be implemented using any suitable general purpose computer or special purpose computer. For example, a mobile phone may be implemented using a special purpose computer. Any such general purpose computer or special purpose computer can include any suitable hardware. For example, as illustrated in example hardware 300 of FIG. 3, such hardware can include hardware processor 302, memory and/or storage 304, an input device controller 306, an input device 308, display/audio drivers 310, display and audio output circuitry 312, communication interface(s) 314, an antenna 316, and a bus 318.

Hardware processor 302 can include any suitable hardware processor, such as a microprocessor, a micro-controller, digital signal processor(s), dedicated logic, and/or any other suitable circuitry for controlling the functioning of a general purpose computer or a special purpose computer in some embodiments. In some embodiments, hardware processor 302 can be controlled by a server program stored in memory and/or storage of a server, such as server 202. In some embodiments, hardware processor 302 can be controlled by a computer program stored in memory and/or storage 304 of user device 306.

Memory and/or storage 304 can be any suitable memory and/or storage for storing programs, data, and/or any other suitable information in some embodiments. For example, memory and/or storage 304 can include random access memory, read-only memory, flash memory, hard disk storage, optical media, and/or any other suitable memory.

Input device controller 306 can be any suitable circuitry for controlling and receiving input from one or more input devices 308 in some embodiments. For example, input device controller 306 can be circuitry for receiving input from a touchscreen, from a keyboard, from one or more buttons, from a voice recognition circuit, from a microphone, from a camera, from an optical sensor, from an accelerometer, from a temperature sensor, from a near field sensor, from a pressure sensor, from an encoder, and/or any other type of input device.

Display/audio drivers 310 can be any suitable circuitry for controlling and driving output to one or more display/audio output devices 312 in some embodiments. For example, display/audio drivers 310 can be circuitry for driving a touchscreen, a flat-panel display, a cathode ray tube display, a projector, a speaker or speakers, and/or any other suitable display and/or presentation devices.

Communication interface(s) 314 can be any suitable circuitry for interfacing with one or more communication networks (e.g., computer network 204). For example, interface(s) 314 can include network interface card circuitry, wireless communication circuitry, and/or any other suitable type of communication network circuitry.

Antenna 316 can be any suitable one or more antennas for wirelessly communicating with a communication network (e.g., communication network 204) in some embodiments. In some embodiments, antenna 316 can be omitted.

Bus 318 can be any suitable mechanism for communicating between two or more components 302, 304, 306, 310, and 314 in some embodiments.

Any other suitable components can be included in hardware 300 in accordance with some embodiments.

In some embodiments, at least some of the above described blocks of the processes of FIG. 1 can be executed or performed in any order or sequence not limited to the order and sequence shown in and described in connection with the figure. Also, some of the above blocks of FIG. 1 can be executed or performed substantially simultaneously where appropriate or in parallel to reduce latency and processing times. Additionally or alternatively, some of the above described blocks of the process of FIG. 1 can be omitted.

In some embodiments, any suitable computer readable media can be used for storing instructions for performing the functions and/or processes herein. For example, in some embodiments, computer readable media can be transitory or non-transitory. For example, non-transitory computer readable media can include media such as non-transitory forms of magnetic media (such as hard disks, floppy disks, and/or any other suitable magnetic media), non-transitory forms of optical media (such as compact discs, digital video discs, Blu-ray discs, and/or any other suitable optical media), non-transitory forms of semiconductor media (such as flash memory, electrically programmable read-only memory (EPROM), electrically erasable programmable read-only memory (EEPROM), and/or any other suitable semiconductor media), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

In situations in which the systems described herein collect personal information about users, or make use of personal information, the users may be provided with an opportunity to control whether programs or features collect user information (e.g., information about a user’s social network, social actions or activities, profession, a user’s preferences, or a user’s current location). In addition, certain data may be treated in one or more ways before it is stored or used, so that personal information is removed. For example, a user’s identity may be treated so that no personally identifiable information can be determined for the user, or a user’s geographic location may be generalized where location information is obtained (such as to a city, ZIP code, or state level), so that a particular location of a user cannot be determined. Thus, the user may have control over how information is collected about the user and used by a content server.

Accordingly, methods, systems, and media identifying relevant content are provided.

Although the invention has been described and illustrated in the foregoing illustrative embodiments, it is understood that the present disclosure has been made only by way of example, and that numerous changes in the details of implementation of the invention can be made without departing from the spirit and scope of the invention, which is limited only by the claims that follow. Features of the disclosed embodiments can be combined and rearranged in various ways.

What is claimed is:

1. A method for identifying relevant content, the method comprising:
receiving campaign parameters that describe a content campaign, wherein the campaign parameters include at least one keyword and at least one URL;
generating a target vector that describes the content campaign based on the at least one keyword and the at least one URL, wherein the target vector maps information associated with the at least one URL and information associated with the at least one keyword to an embedding space;
determining a similarity of the target vector to a plurality of channel vectors associated with each of a plurality of content creators, wherein each of the plurality of channel vectors maps information associated with each of the plurality of content creators to the embedding space;
selecting one or more content creators from the plurality of content creators based on the similarity of the target vector to each of the plurality of channel vectors; and
causing the one or more content creators to be presented for selection to participate in the content campaign.

2. The method of claim 1, further comprising parsing a page associated with the at least one URL to determine a plurality of verticals that appear on the page.

3. The method of claim 2, wherein the target vector combines the plurality of verticals corresponding to the at least one URL and the at least one keyword.

4. The method of claim 3, wherein a weight is applied to each of the plurality of verticals and the at least one keyword and wherein a total weight of the plurality of verticals corresponds with the weight applied to the at least one keyword.

5. The method of claim 1, further comprising generating a plurality of query embedded vectors for the campaign, wherein the target vector is an average of the plurality of query embedded vectors.

6. The method of claim 1, further comprising generating a plurality of channel embedded vectors for a channel, wherein the channel vector is an average of the plurality of channel embedded vectors.

7. The method of claim 1, wherein the similarity of the target vector to the plurality of channel vectors associated with each of the plurality of content creators is determined by calculating cosine similarity between the target vector and each of the plurality of channel vectors.

8. The method of claim 7, wherein the one or more content creators are selected from the plurality of content creators based on the cosine similarity between the target vector and a channel vector being greater than a threshold value.

9. The method of claim 1, further comprising:
parsing a page associated with the at least one URL to determine a plurality of verticals that appear on the page;
determining an audience affinity score that estimates a portion of an audience of for the one or more content creators, wherein the audience affinity score for a content creator is based on the plurality of verticals corresponding to the at least one URL; and
sorting the one or more content creators based on the audience affinity score.

10. The method of claim 1, further comprising causing a user interface to be presented, wherein the user interface concurrently presents the campaign parameters with the one or more content creators for selection to participate in the content campaign, wherein each of the campaign parameters is adjustable to modify the one or more content creators that has been automatically selected as a candidate to participate in the content campaign.

11. A system for identifying relevant content, the system comprising:
a hardware processor that:
receives campaign parameters that describe a content campaign, wherein the campaign parameters include at least one keyword and at least one URL;
generates a target vector that describes the content campaign based on the at least one keyword and the at least one URL, wherein the target vector maps information associated with the at least one URL and information associated with the at least one keyword to an embedding space;
determines a similarity of the target vector to a plurality of channel vectors associated with each of a plurality of content creators, wherein each of the plurality of channel vectors maps information associated with each of the plurality of content creators to the embedding space;
selects one or more content creators from the plurality of content creators based on the similarity of the target vector to each of the plurality of channel vectors; and
causes the one or more content creators to be presented for selection to participate in the content campaign.

12. The system of claim 11, wherein the hardware processor further parses a page associated with the at least one URL to determine a plurality of verticals that appear on the page.

13. The system of claim 12, wherein the target vector combines the plurality of verticals corresponding to the at least one URL and the at least one keyword.

14. The system of claim 13, wherein a weight is applied to each of the plurality of verticals and the at least one keyword and wherein a total weight of the plurality of verticals corresponds with the weight applied to the at least one keyword.

15. The system of claim 11, wherein the hardware processor further generates a plurality of query embedded vectors for the campaign, wherein the target vector is an average of the plurality of query embedded vectors.

16. The system of claim 11, wherein the hardware processor further generates a plurality of channel embedded vectors for a channel, wherein the channel vector is an average of the plurality of channel embedded vectors.

17. The system of claim 11, wherein the similarity of the target vector to the plurality of channel vectors associated with each of the plurality of content creators is determined by calculating cosine similarity between the target vector and each of the plurality of channel vectors.

18. The system of claim 17, wherein the one or more content creators are selected from the plurality of content creators based on the cosine similarity between the target vector and a channel vector being greater than a threshold value.

19. The system of claim 11, wherein the hardware processor further:
parses a page associated with the at least one URL to determine a plurality of verticals that appear on the page;
determines an audience affinity score that estimates a portion of an audience of for the one or more content creators, wherein the audience affinity score for a content creator is based on the plurality of verticals corresponding to the at least one URL; and
sorts the one or more content creators based on the audience affinity score.

20. The system of claim 11, wherein the hardware processor further causes a user interface to be presented, wherein the user interface concurrently presents the campaign parameters with the one or more content creators for selection to participate in the content campaign, wherein each of the campaign parameters is adjustable to modify the one or more content creators that has been automatically selected as a candidate to participate in the content campaign.

21. A non-transitory computer-readable medium containing computer-executable instructions that, when executed by a processor, cause the processor to perform a method for identifying relevant content, the method comprising:
receiving campaign parameters that describe a content campaign, wherein the campaign parameters include at least one keyword and at least one URL;
generating a target vector that describes the content campaign based on the at least one keyword and the at least one URL, wherein the target vector maps information associated with the at least one URL and information associated with the at least one keyword to an embedding space;
determining a similarity of the target vector to a plurality of channel vectors associated with each of a plurality of content creators, wherein each of the plurality of channel vectors maps information associated with each of the plurality of content creators to the embedding space;
selecting one or more content creators from the plurality of content creators based on the similarity of the target vector to each of the plurality of channel vectors; and
causing the one or more content creators to be presented for selection to participate in the content campaign.
